(19) United States
(12) Patent Application Publication
(10) Pub. No.: US 2023/0216258 A1
(43) Pub. Date: Jul. 6, 2023

(54) POWER EXTENSION CORD SOCKET

(71) Applicant: MIN-CHANG LAN, TAOYUAN CITY (TW)

(72) Inventor: MIN-CHANG LAN, TAOYUAN CITY (TW)

(21) Appl. No.: 17/567,896

(22) Filed: Jan. 4, 2022

(51) Int. Cl. H01R 27/02; H01R 25/00; H01R 13/717; H01R 13/713; H01R 13/66

(52) U.S. Cl. CPC H01R 27/02; H01R 25/003; H01R 13/7175; H01R 13/713; H01R 13/6666; H01R 13/6683; H05B 47/11

(57) ABSTRACT

A power extension cord socket includes a first socket device and a control device. The first socket device has plural AC power sockets and AC power switches, and each AC power socket is provided for plugging an external load to forward mains electricity, and each AC power switch is connected to the respective AC power socket for controlling the open circuit or closed circuit of the AC power socket. The control device is coupled to the mains electricity and electrically connected to the first socket device. The control device has a leakage detection processor and a leakage power-off switch and uses the leakage detection processor to detect a current usage status of the first socket device, and turns on the leakage power-off switch in an abnormal status to stop each AC power socket from forwarding the mains electricity to the load.

### BACKGROUND

### Technical Field

The present disclosure relates to a power supply device, and more particularly to a power extension cord socket with a multiple of functions including leakage protection, USB slots, night lights, etc. to meet user requirements and achieve the effect of improving the safety and comfort of life.

### Description of Related Art

The advancement of science and technology has brought civilization and convenience, but also has caused increasingly more productions of the electrical appliances and equipment. The energy source for various different electrical appliances and equipment is supplied by the electricity company and sent the power sockets at different places through a cable to facilitate the general public to access the electrical energy by plugging the electrical appliances and equipment into the power sockets directly. In other words, the power sockets are usually built at fixed positons on a wall and with a limited quantity. In order to let the electrical appliances and equipment receive electrical energy from a required position, the general public often extend the socket to the required position by an external power extension cord. In the process of using the power extension cord to adjust the position and quantity of the sockets, accidents such as fire accidents caused by overloading and burning occur frequently, even though the conventional power extension cord usually comes with an overload protector which is electrically connected to each socket and the overload protector of the electrical appliance and equipment can immediately disconnect the circuit of the socket whenever too many sockets are used at the same time or the sockets are overloaded with current. The overload protector can prevent accidents caused by the damage or burning of the electrical appliances and equipment, or the power extension cord.

However, the aforementioned power supply opens the circuit of the socket when there is an excessive amount of current due to the overload, and it does not provide any protective measures for the abnormal amount of current. Therefore, it is a main subject for related manufactures as well as the present disclosure to find a way to detect the amount of current when the appliances and equipment have a leakage problem and to disconnect the circuit of the socket to overcome the drawbacks of the prior art and improve the household electrical safety.

### SUMMARY

In view of the aforementioned problems, it is a primary objective of the present disclosure to provide a power extension cord socket capable of performing a background detection of the current usage status, and automatically disconnect the power of the socket when a plugged electrical appliance has a leakage, so as to ensure the safety of using electricity in daily life.

To achieve the foregoing and other objectives, the present disclosure discloses a power extension cord socket, comprising: a first socket device, having a plurality of AC power sockets and a plurality of AC power switches, and each AC power socket being provided for plugging an external load to forward mains electricity, and each AC power switch is coupled to the respective AC power socket, for controlling an open circuit or closed circuit of the AC power socket; and a control device, coupled to the mains electricity, and electrically coupled to the first socket device, and the control device having a leakage detection processor and a leakage power-off switch, and the control device using the leakage detection processor to detect a current usage status of the first socket device, and turn on the leakage power-off switch in an abnormal status, so that each AC power socket stops forwarding the mains electricity to the load.

Wherein, the power extension cord socket further comprises a night light device electrically coupled to the control device and having a three-stage night light switch is located on the night light device for selectively switching to an automatic detection mode, a constant lit mode and an off mode. The night light device has a photoresistor and at least one LED light, and the photoresistor is electrically coupled to the three-stage night light switch and the LED light, and when the three-stage night light switch is switched to the automatic detection mode, the control device senses an ambient brightness by the photoresistor to drive the operation of the LED light. The power extension cord socket further comprises a second socket device electrically coupled to the control device and installed between the first socket device and the night light device, and the second socket device has at least one DC power jack. The DC power jack is a USB slot for different types of use, and the USB slots provide a direct current of 1˜3.1 amperes (A) or 2˜3.1 A to the load. In addition, the control device further comprises an overload detection processor and an overload protection switch, and the control device uses the overload detection processor to detect the current usage status of the first socket device and the second socket device, and when the current usage status exceeds a rated value, the overload protection switch is turned on, so that each AC power socket and each DC power jack stop forwarding the mains electricity to the load, and the night light device stops its operation at the same time. The control device further comprises a surge protection processor for preventing a surge voltage from entering into the first socket device. The leakage power-off switch is an electromagnetic relay. The control device uses the leakage detection processor to detect and record a current usage status of each AC power socket, and turn off the corresponding AC power switch when the current usage status of said each AC power socket is abnormal.

In summation of the description above, the control device detects the current usage status of the socket and automatically disconnect the supply of mains electricity in abnormal conditions, and thus improving the power supply quality of the power extension cord socket and ensuring the safety of the users. In addition, the power extension cord socket has the night light device with a three-stage operating mode to further achieve the effects of providing appropriate lighting to users, facilitating night-time use, and being used as a small night light, so as to increase the overall economic value of the product.

### BRIEF DESCRIPTION OF THE DRAWINGS

FIG. 1 is a perspective view of a first preferred embodiment of this disclosure;

FIG. 2 is a block diagram of a second preferred embodiment of the present disclosure;

FIG. 3 is a perspective view of a second preferred embodiment of this disclosure;

FIG. 4 is a perspective view of a third preferred embodiment of this disclosure;

FIG. 5 is a top view of the third preferred embodiment of the present disclosure;

FIG. 6 is a bottom view of the third preferred embodiment of the present disclosure;

FIG. 7 is a left-side view of the third preferred embodiment of the present disclosure;

FIG. 8 is a right-side view of the third preferred embodiment of the present disclosure;

FIG. 9 is a front view of the third preferred embodiment of the present disclosure;

FIG. 10 is a rear view of the third preferred embodiment of the present disclosure; and

FIG. 11 is a schematic view of an application of the third preferred embodiment of the present disclosure.

### DESCRIPTION OF THE EMBODIMENTS

This disclosure will now be described in more detail hereinafter with reference to the accompanying drawings that show various embodiments of the invention.

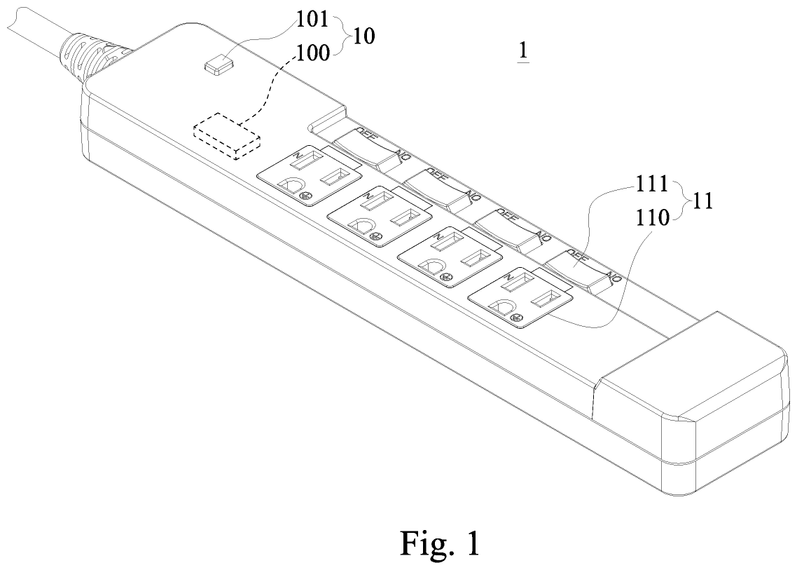

With reference to FIG. 1 for the schematic view of a power extension cord socket 1 in accordance with the first preferred embodiment of the present disclosure, the power extension cord socket 1 comprises a control device 10 and a first socket device 11. The control device 10 is coupled to mains electricity and electrically coupled to the first socket device 11. The control device 10 has a leakage detection processor 100 and a leakage power-off switch 101, and the first socket device 11 has a plurality of AC power sockets 110 and a plurality of AC power switches 111. Each AC power socket 110 is provided for plugging an external load to forward the mains electricity, and each the AC power switch 111 is coupled to the corresponding AC power socket 110 and provided for controlling an open circuit or a closed circuit of the AC power socket 110. The control device 10 uses the leakage detection processor 100 to detect a current usage status of the first socket device 11, and turn on the leakage power-off switch 101, so that each AC power socket stops forwarding the mains electricity to the load.

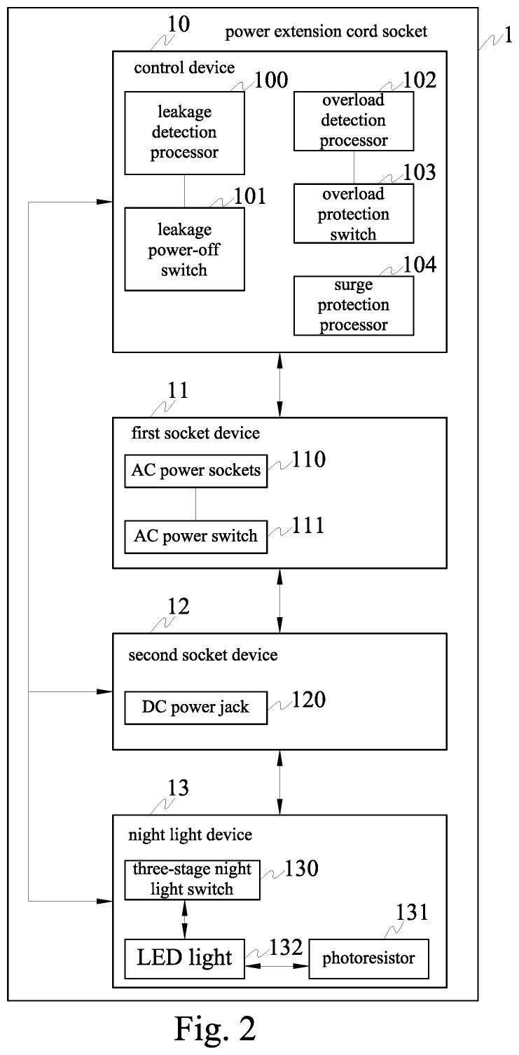

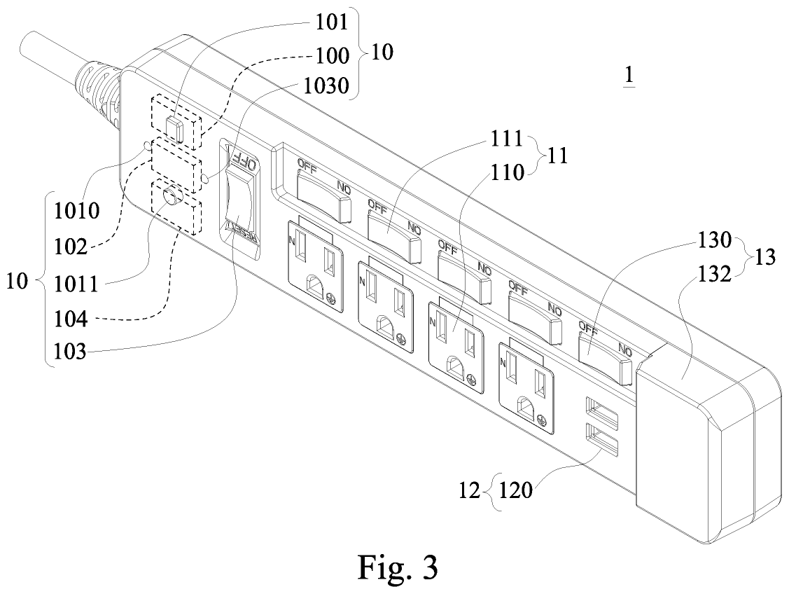

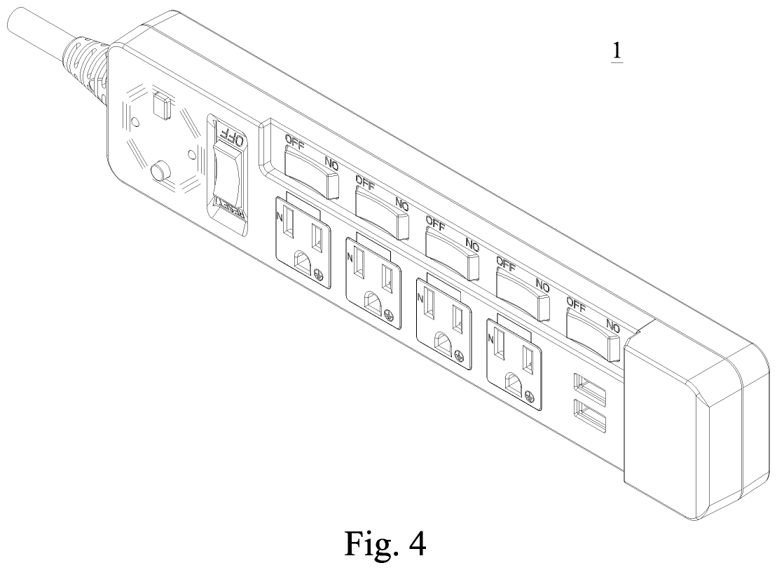

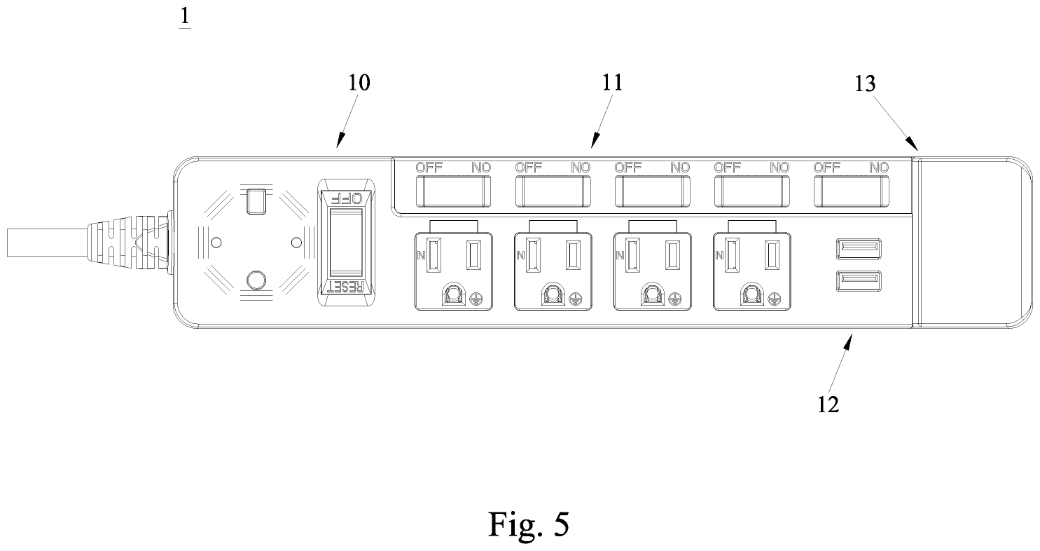

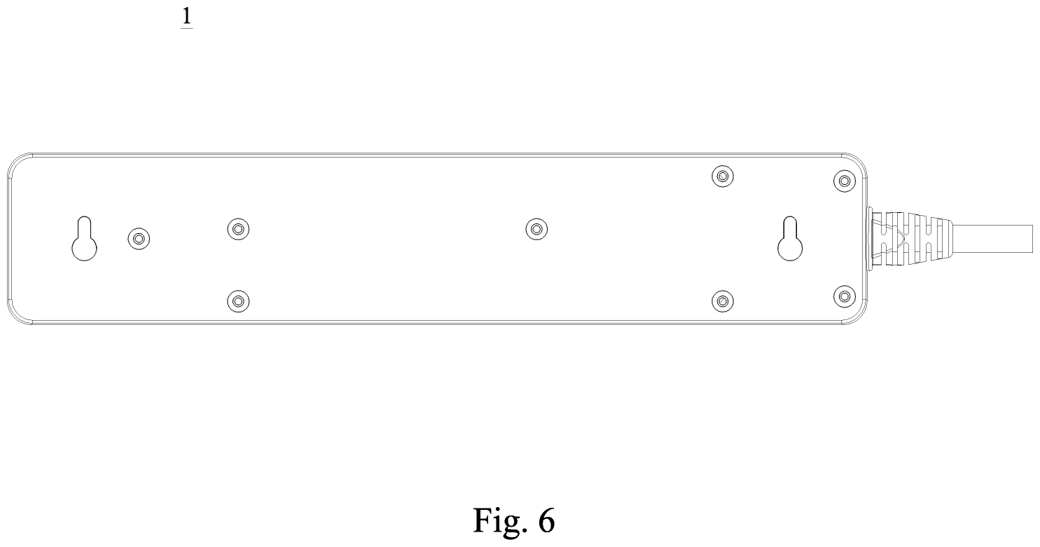

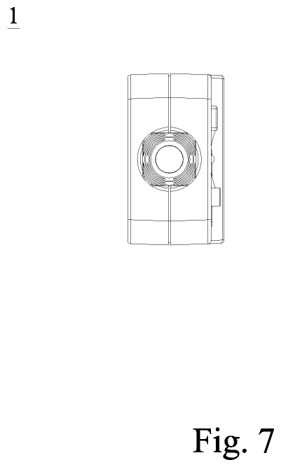

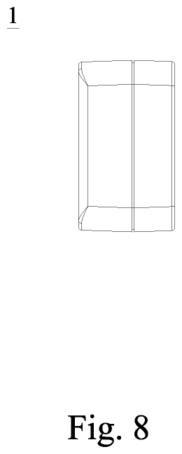

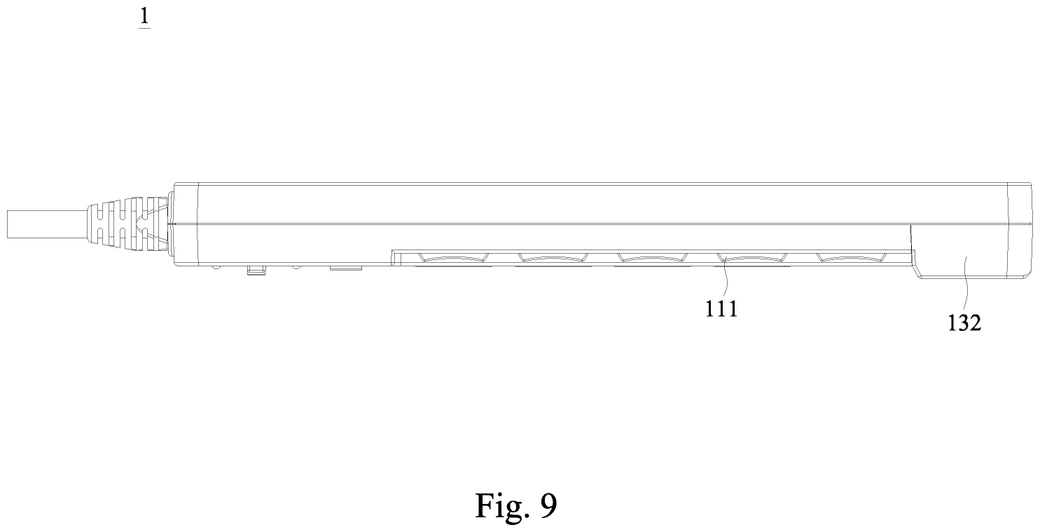

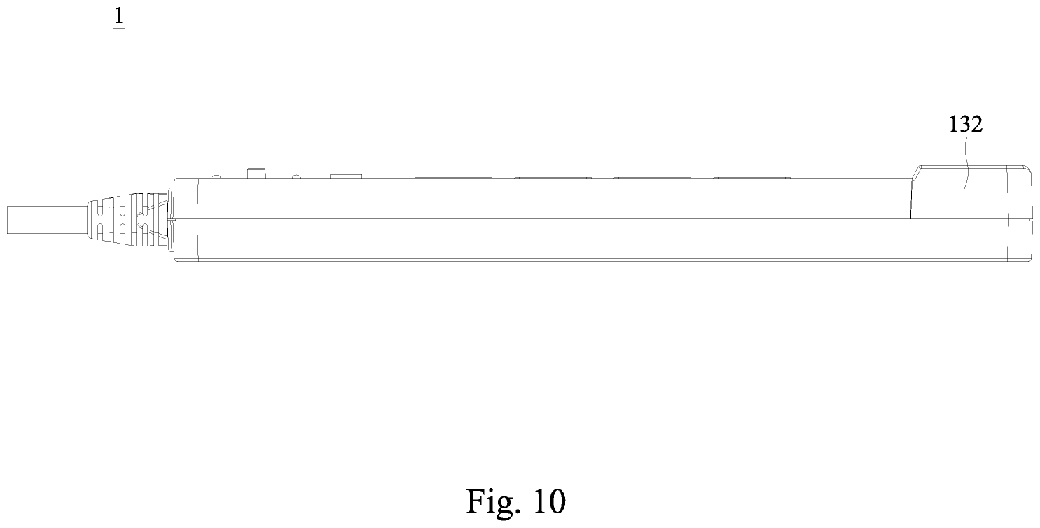

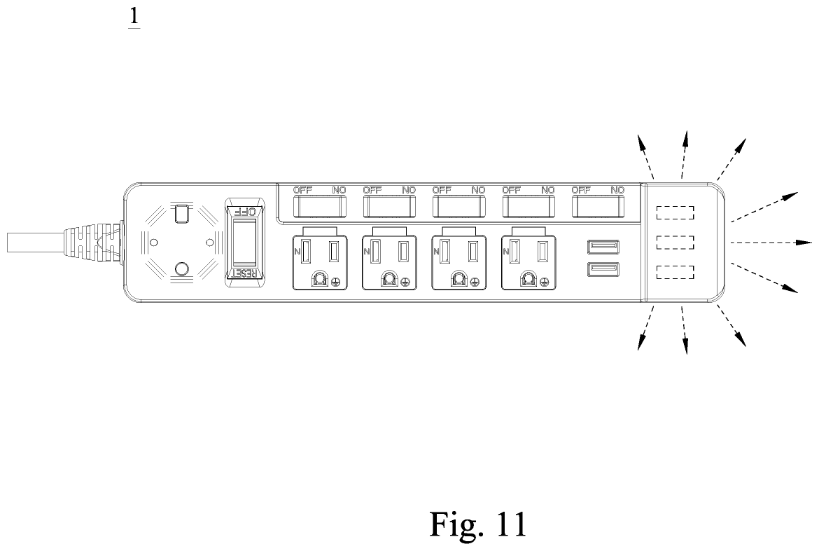

With reference to FIGS. 2-11 for the schematic views of the first and second preferred embodiments of the present disclosure respectively, the power extension cord socket 1 comprises a control device 10, a first socket device 11, a second socket device 12 and a night light device 13, and the second socket device 12 is installed between the first socket device 11 and the night light device 13. The control device 10 is coupled to mains electricity and electrically coupled to the first socket device 11, the second socket device 12 and the night light device 13, and the control device 10 has a leakage detection processor 100, a leakage power-off switch 101, a leakage indicator light 1010, a leakage test key 1011, an overload detection processor 102, an overload protection switch 103, an overload indicator light 1030 and a surge protection processor 104. The first socket device 11 has a plurality of AC power sockets 110 and a plurality of AC power switches 111, and the second socket device 12 has at least one DC power jack 120 such as a USB slot for different types of use, which provides a direct current of 1˜3.1 amperes (A) or 2˜3.1 amperes (A) to an external load, and the second socket device 12 has a USB switch (not shown in the figures) for controlling the ON and OFF of the DC power jack 120. The night light device 13 has a three-stage night light switch 130, a photoresistor 131 and at least one LED light 132, and the photoresistor 131 is electrically coupled to the three-stage night light switch 130 and the LED light 132.

Each AC power socket 110 is provided for plugging the load to forward mains electricity, and each AC power switch 111 is coupled to the corresponding AC power socket 110 and provided for controlling an open circuit or a closed circuit of the AC power socket 110. The surge protection processor 104 is provided for preventing a surge voltage from entering into the first socket device 11, or even into the second socket device 12 and the night light device 13, and the control device 10 uses the leakage detection processor 100 to detect a current usage status of the first socket device 11, and lighting up the leakage indicator light 1010 and automatically turns on the leakage power-off switch 101 such as electromagnetic relay in an abnormal status, so that each the AC power socket 110 stops forwarding the mains electricity to the load. Meanwhile, the control device 10 uses the overload detection processor 102 to detect the current usage status of the first socket device 11 and the second socket device 12, and lights up the overload indicator light 1030 and automatically turns on the overload protection switch when the current usage status exceeds a rated value, and each AC power socket 110 and the DC power jack 120 stop forwarding the mains electricity to the load, the night light device 13 also stops its operation. It is noteworthy that a user can use the leakage test key 1011 any time to test whether the leakage detection processor 100 works normally.

In addition, the three-stage night light switch 130 is provided for selectively switching to an automatic detection mode, a constant lit mode and an off mode. When the three-stage night light switch 130 is switched to the automatic detection mode, the control device 10 uses the photoresistor 131 to sense the ambient brightness and drive the LED light 132 to emit light, and the night light device 13 can have a knob used for adjusting the brightness of the LED light 132. In another implementation mode of this embodiment, the control device 10 can also use the leakage detection processor 100 to detect and record the current usage status of each AC power socket 110, and turns off the corresponding AC power switch 111 when current usage status of the AC power socket 110 is abnormal. Therefore, when the control device 10 detects and finds that if there is a leakage of the load that is plugged into any one of the AC power sockets 110, the control device 10 will turn off the corresponding AC power switch 111 immediately and disconnect the supply of the mains electricity directly. The present disclosure not just ensures the safety of electricity use only, but also facilitates the user to discover any abnormal load and assists the user to control the condition of the electric appliances and improve the safety of life.

What is claimed is:

1. A power extension cord socket, comprising:
a first socket device, having a plurality of AC power sockets and a plurality of AC power switches, and each AC power socket being provided for plugging an external load to forward mains electricity, and each AC power switch is coupled to the AC power socket respectively, for controlling an open circuit or closed circuit of the AC power socket; and
a control device, coupled to the mains electricity, and electrically coupled to the first socket device, and the control device having a leakage detection processor and a leakage power-off switch, and the control device using the leakage detection processor to detect a current usage status of the first socket device, and turn on the leakage power-off switch in an abnormal status, so that each AC power socket stops forwarding the mains electricity to the load.

2. The power extension cord socket according to claim 1, further comprising a night light device, electrically coupled to the control device, and a three-stage night light switch is located on the night light device for selectively switching to an automatic detection mode, a constant lit mode and an off mode.

3. The power extension cord socket according to claim 2, wherein the night light device has a photoresistor and at least one LED light, and the photoresistor is electrically coupled to the three-stage night light switch and the LED light, and when the three-stage night light switch is switched to the automatic detection mode, the control device senses an ambient brightness by the photoresistor to drive the LED light.

4. The power extension cord socket according to claim 3, further comprising a second socket device electrically coupled to the control device and installed between the first socket device and the night light device, and the second socket device having at least one DC power jack.

5. The power extension cord socket according to claim 4, wherein the DC power jack is a USB slot for different types of use.

6. The power extension cord socket according to claim 5, wherein the USB slots provide a direct current of 1˜3.1 amperes or 2˜3.1 amperes to the load.

7. The power extension cord socket according to claim 3, wherein the control device further comprises an overload detection processor and an overload protection switch, and the control device uses the overload detection processor to detect the current usage status of the first socket device and the second socket device, and when the current usage status exceeds a rated value, the overload protection switch is turned on, so that each AC power socket and each DC power jack stop forwarding the mains electricity to the load, and the night light device stops its operation at the same time.

8. The power extension cord socket according to claim 7, wherein the control device further comprises a surge protection processor for preventing a surge voltage from entering into the first socket device.

9. The power extension cord socket according to claim 8, wherein the leakage power-off switch is an electromagnetic relay.

10. The power extension cord socket according to claim 8, wherein the control device uses the leakage detection processor to detect and record a current usage status of each AC power socket, and turn off the corresponding AC power switch when the current usage status of said each AC power socket is abnormal.
